(19) United States
(12) Patent Application Publication
(10) Pub. No.: US 2011/0045852 A1
(43) Pub. Date: Feb. 24, 2011

(54) SYSTEM AND METHOD UTILIZING CAMERA-EQUIPPED CELLULAR TELEPHONES

(76) Inventor: ARAM KOVACH, LEWIS CENTER, OH (US)

Correspondence Address: ELEY LAW FIRM CO., 7870 OLENTANGY RIVER RD, SUITE 311, COLUMBUS, OH, 43235, US

(21) Appl. No.: 12/860,883

(22) Filed: Aug. 21, 2010

Related U.S. Application Data
(60) Provisional application No. 61/236,051, filed on Aug. 21, 2009.
(60) Provisional application No. 61/298,197, filed on Jan. 25, 2010.

(51) Int. Cl. H04W 4/12

(52) U.S. Cl. 455/466

(57) ABSTRACT

A system and method for exchanging information relating to an electronic image. An image of interest is recorded with a camera-equipped cellular telephone. A cellular telephone network is utilized to transmit the recorded image to at least one remote server. The image is decoded at the remote server to generate a corresponding dataset. The dataset is processed at the remote server in a predetermined manner to generate a response corresponding to the dataset. The response is sent from the remote server to the cellular telephone by means of the cellular network.

This application claims priority to U.S. provisional application 61/236,051, filed Aug. 21, 2009, and to U.S. provisional application 61/298,197, filed Jan. 25, 2010, the entire contents of each being incorporated herein by reference thereto.

### FIELD

The present invention relates generally to cellular telephones, in particular to a system that utilizes camera-equipped cellular telephones to send images recorded by the cellular telephone and to receive stored information corresponding to the images.

### BACKGROUND

Camera-equipped cellular telephones have become commonplace. However, the image-capturing capability of these cellular telephones is typically utilized merely to record images and share them with others. There is a need for a way to utilize the image-capturing capability of camera-equipped cellular telephones to serve as a data input device. There is a further need for a way to utilize data relating to the captured image to provide information and services.

### SUMMARY

The present invention discloses several embodiments of a system that utilizes camera-equipped cellular telephones to send images recorded by the cellular telephone and to receive information and services relating to the images. Examples include periodic reminders for replacing consumable goods and schedule reminders. Additional example services include exchange of contact information and purchase or transfer of goods. The present invention may also be utilized to trace products through various streams of commerce or to evoke downloaded commercial advertising based upon a photographed image sent by cellular telephone.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 is a diagram of a system utilizing a camera-equipped cellular telephone according to an embodiment of the present invention;

FIG. 2 provides details of an example embodiment of the system of FIG. 1;

FIGS. 3a through 3d provide details of another example embodiment of the system of FIG. 1; and

FIG. 4 provides details of an anti-counterfeiting system according to an embodiment of the present invention.

### DETAILED DESCRIPTION

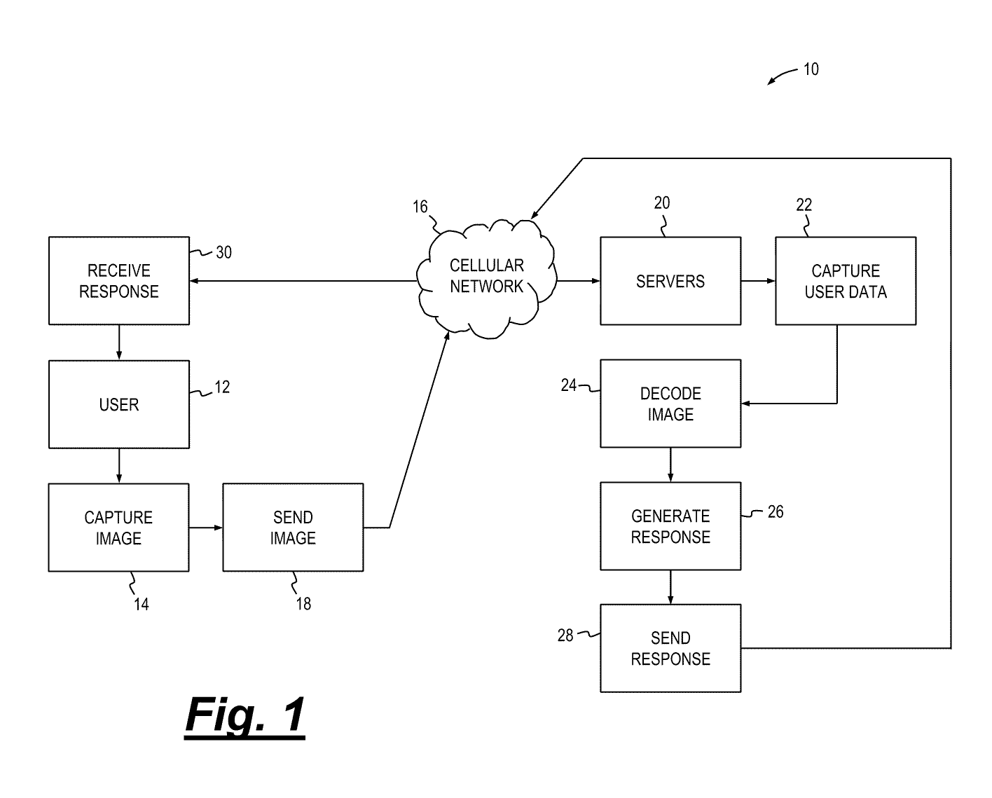

The general arrangement of a commerce system 10 (hereafter “system 10”) utilizing camera-equipped cellular telephones is shown in FIG. 1 according to an embodiment of the present invention. A user 12 records an image of interest 14 with a camera-equipped cellular telephone and utilizes a cellular telephone network 16 to transmit at 18 the recorded image to one or more remote servers 20 maintained by an operator of system 10. User 12 data, such as the cellular telephone number, name, address and demographic information relating to the user, may be captured at 22 and stored in a database or data warehouse for later use. The received image is decoded at 24 with image-recognition equipment and/or software to generate a corresponding dataset. The dataset is processed at 26 in a predetermined manner 26 to generate a response corresponding to the dataset. At 28 the response is sent to user 12 via cellular network 16. User 12 receives the response at 30 and may utilize the response as desired.

The present invention may be utilized to advantage in a number of ways. The following examples, described with reference to FIG. 1, are for purposes of illustration only and are not intended to be limiting in any way.

### I. mobiBiz—“Your Face is Your Business Card.”

A photograph of a business acquaintance (i.e., an associate, customer, client, etc.) is taken at 14 with a camera-equipped cellular telephone. The cellular telephone is then utilized to send, at 18, the image to a predetermined internet website comprising elements 20 through 28. The website processes the image at 24 and sends, at 26, 28, to the cellular telephone a vCard for the business acquaintance in a standardized format. The vCard may include the image captured at 14. When the vCard is saved, the telephone's contact database is updated.

This embodiment of system 10 allows a user 12 to take a picture of someone and get back his or her vCard. Instead of just handing out a business card that may or may not be added to an important client's database, a user 12 may instead instruct the client to take the user's picture with a camera-equipped cellular telephone. The client will receive, on the cellular telephone, business card information and profile data relating to user 12, complete with pictures. The business information can be easily added to Outlook or other contact managers. Additionally, the client may receive a link to a website or an introductory video relating to user 12. Accordingly, user 12 will stand out and be remembered by clients. In addition, user 12 may take a picture of the client's business card at 14 and utilize elements 16 through 30 to activate a mobiBiz account for the client.

User 12 may manage their business profile, change the image captured at 14 (professional head shot, perhaps) and update information received relating to clients. User 12 may also add pictures to their existing contact database, such as adding photos to the contacts in the database. User 12 may further “collect” pictures of contacts as when activating the contacts' mobiBiz capability while showing them the business tool. User 12 may advise the contacts that an email will be sent to them inviting them to register at mobiWorld.me for increased functionality.

The image of 14 may originate from a cell phone, or may be an uploaded image supplied when registering on a predetermined internet website such as mobiWorld. For example, a user 12 may upload a professional head shot or have a webcam take a picture. If a user 12 wants mobiBiz functionality they need only fill out their business information on the website and it will be linked it to the picture.

The disclosed system may include the capability for the website to automatically crop any picture sent in and make it just a head shot, if desired.

Salesmen in particular will benefit from the present invention, for several reasons. Firstly, it gives them something new and interesting to demonstrate to their clients. This increases their chances that the client will put them in their contact list, and it adds their picture to their client's contact database. Many clients likely have few pictures in their contact list, so it will stand out.

In an example scenario, after the salesman impresses his client with the present invention, he says . . . “I'll hook you up. Let me take your picture.” He sends it to a predetermined internet website, such as biz@jam.tw or even better, since he is a registered user, he simply starts the mobiBiz app on his phone. “When I get back to the office I'll link your business card info to your picture for you. When you are out and want to impress your associates, have them take your picture and send it to biz@jam.tw. You'll get an email from mobiBiz when you are activated.”

Such activities may become “viral” in nature, as users 12 will want to add pictures to their contact database. When people are out with associates or friends, they can say, “let me take your picture and I'll hook you up with mobiBiz.” When they log onto mobiWorld all the pictures they have taken and sent to mobiBiz will be there, then they simply import the person's business info and link their picture. The newly active person will receive an email from the website congratulating him and inviting him to join the mobi revolution as a member.

In some embodiments the camera-equipped cellular telephone may be utilized to record an image of a business card and utilize optical character recognition to fill out the person's business information.

### II. Loyalty Cards

In another embodiment of the present invention users 12 load information relating to their customer loyalty cards into their phone, eliminating the need to carry the loyalty card in their wallet or on their keychain. Users 12 will take a picture of their card at 14 and associate the card with the loyalty program. The present invention recognizes the barcode portion of a loyalty card image sent to a predetermined internet website comprising elements 20-28 and digitizes it to create a new, clean barcode. The new barcode is sent to the telephone at 28 and stored in the telephone's memory at 30. When the user 12 visits a store and wishes to utilize a loyalty card the user simply calls up the customer loyalty barcode stored on the phone for a cashier to scan.

### III. mobiSave—Take a Picture of a Coupon, Use it in Your Favorite Store

Since the economic downturn, coupon redemption is up 15%; people are looking to save money. Currently, couponing is a bit of a hassle with all the cutting, sorting, organizing and extra time in the checkout line. But people still do it, in ever increasing numbers. The present invention makes this process much easier. When registering to become mobiEnabled, a user 12 takes at 14 a picture of the barcode on all their customer loyalty cards. System 10 includes means to link the user's account of element 22 to their point of sale. When user 12 loads the coupons into mobiWorld, comprising elements 20-28, they are automatically loaded onto the user's account. Optionally, the coupons may be set to expire a predetermined number of days after being uploaded or on a predetermined date. When an item linked to a coupon is scanned at purchase the respective amount is deducted from the bill of user 12. User 12 may select coupons by taking pictures of normal print coupons, or digital coupons found online. Stores may display signs reading “This Store is mobiEnabled” or the like, encouraging participating consumers. In-store promotions may also be conducted wherein a user 12 records at 14 a picture of a promotional item and has the savings deducted automatically at checkout.

System 10 may further include means to electronically store the loyalty cards of user 12 on their phone and catalog them. When user 12 reaches the checkout, they simply display the appropriate loyalty card on their phone and scan the image. User 12 may participate on any level, just to have the convenience of carrying around fewer cards, or take advantage of all the benefits of being mobiEnabled.

Additionally, manufacturers, retailers and advertisers (hereafter “vendors”) benefit greatly as system 10 may include data gathering at 22. For example, vendors may see in “real time” how well their new coupon promotion and ad campaign are received by consumers. Vendors are informed when the coupons are uploaded and when they are redeemed, allowing them to track consumer response more quickly and efficiently. For example, if vendors know 50,000 people uploaded a coupon for the new Sara Lee pie on Sunday, but only 10,000 redeemed them before the expiration date 60 days later, this information can be used immediately allowing them to proceed accordingly without waiting to receive the redeemed coupons from retailers. Such cost-effective assessment and tracking of consumer intent has never before been available and is an invaluable tool in determining promotion appeal much sooner.

On the mobiWorld link, a user 12 will be able to see all of their cataloged coupons, complete with expiration dates. User 12 can set up a shopping list of regularly purchased items, categorized by area of the store. To accomplish this user 12 may drag the coupons to a list to print out or send it to their phone to take to the store. Similarly, a family member may make a list and email it to another family member's phone, thus avoiding missed items during shopping trips or not using a coupon because it wasn't in their possession.

MobiEnabled stores may also provide a floor layout in a response 26 sent at 28 and received at 30 so user 12 may plot the easiest shopping course to save time and be more efficient. Studies have shown that the most organized shoppers buy more products per trip than people without a plan.

Recently, Kentucky Fried Chicken gave away a free Grilled Chicken meal on Oprah Winfrey's television show. It was initially hailed as a public relations coup and created tremendous buzz in the industry. It turned into a fiasco. They were severely unprepared for the influx of interest. They made an educated guess on the turnout and kept track of downloads. However, they did not anticipate the coupons being photocopied and distributed. By using mobiSave to administer the coupons to cell phones, KFC could have added valuable metric information, anticipated demand and had a positive marketing campaign. Instead, it turned into a PR nightmare with the overall consensus is that their brand, and new product, has been damaged. Millions of dollars were lost on the promotion itself, currently and in the future. The present invention provides a better way to measure and achieve the desired marketing goals.

### IV. Air Filter Change Reminder

In this embodiment of the present invention a purchaser 12 of a home air filter records an image at 14 of a tag affixed to packaging for the filter. At 18 the purchaser 12 sends, via network 16, the photo to a predetermined service provider at a known phone number or web site, comprising elements 20-28, and registers at 22 by supplying predetermined information such as name, physical address, email address telephone number, demographic information, etc. The service provider subsequently sends at 28, 30, via network 16, a text message reminder to the purchaser's cellular telephone or email address when the filter is to be replaced. The service provider may also send the purchaser 12 ancillary information such as the part number of the originally-purchased filter, part numbers of other compatible filters, and accessories that may be used with the filter or the heating/cooling system into which the filter is installed.

### V. Transfer Sporting Event Tickets

The present invention may be used to transfer tickets to a sporting event from one ticket holder to another. In this embodiment a ticket holder (“transferor”) 12 records at 14 an image relating to the event with a cellular telephone and sends the image, via network 16, to a predetermined service provider via the cellular telephone. The service provider of elements 20-28 replies to the transferor with a link to an internet website, the website providing a data input form for the transferor to enter transferee information. The transferor 12 also receives a confirmation code, which the transferor sends to the transferee's cellular telephone via network 16. The transferee cellular telephone subsequently receives a link to a predetermined internet website from the service provider. Upon visiting the website the transferee enters the confirmation code. The website replies at 28, 30 with a visual image of a barcode representing the transferred tickets. Upon arrival at the sporting event the transferee need only present the cellular telephone with the barcode image of 30 to a ticket-taker, who scans the image to receive the tickets.

### VI. Television-Based Shopping

In this embodiment a user 12 views commercials broadcast via television. When goods or services of interest are presented the user records at 14 an image of the commercial with a camera-equipped cellular telephone and sends the image, via network 16, to a predetermined service provider comprising elements 20-28 via the cellular telephone. The service provider replies, via network 16, with information relating to the select goods and services, and provides means for e-commerce-based purchase of the goods.

### VII. Refuse Pickup Reminder

The present invention may be used to receive reminders regarding refuse and recycling pickup. A subscriber 12 records at 14 an image of a tag or other information present on a container provided by the refuse collector. At 18 the subscriber 12 sends the photo, via network 16, to a predetermined service provider comprising elements 20-28 at a known phone number or web site, and registers at 22 by supplying predetermined information such as name, physical address, email address telephone number, demographic information, etc. The service provider subsequently sends at 28, via network 16, a text message reminder to the subscriber's cellular telephone or email address at 30 when the refuse is to be collected.

### VIII. Vehicle Oil Change Reminder

The present invention may be used to receive reminders regarding periodic maintenance for a vehicle, such as oil changes. A customer 12 records at 14 an image of a tag or other information relating to the service shop or the vehicle. The customer 12 sends at 18, via network 16, the photo to a predetermined service provider comprising elements 20-28 at a known phone number or web site, and registers by supplying predetermined information such as name, physical address, email address telephone number, demographic information, etc. The service provider subsequently sends a text message reminder to the subscriber's cellular telephone or email address when periodic vehicle maintenance is required.

### IX. Reference Information

The present invention may be used as a source of reference information. For example, a user 12 may record at 14 an image of a weed present in the user's garden. The user sends the photo at 18, via network 16, to a predetermined service provider comprising elements 20-28 at a known phone number or web site, and registers at 22 by supplying predetermined information such as name, physical address, email address telephone number, demographic information, etc. The service provider subsequently sends at 28, via network 16, a text message or internet website link to the user at 30 with information on options to rid the garden of the weed.

### X. Consumer Products

Users 12 may record at 14 an image of various consumer products with a camera-equipped cellular telephone and send the photo, via network 16, to a predetermined service provider comprising elements 20-28 at a known phone number or web site, and registers at 22 by supplying predetermined information such as name, physical address, email address telephone number, demographic information, etc. The service provider subsequently sends at 28, via network 16, information to the user 12 relating to the products such as nearby vendors of the products, similar products, instructional information, promotional advertising and discount coupons.

### XI. Twin-Locating Amusement System

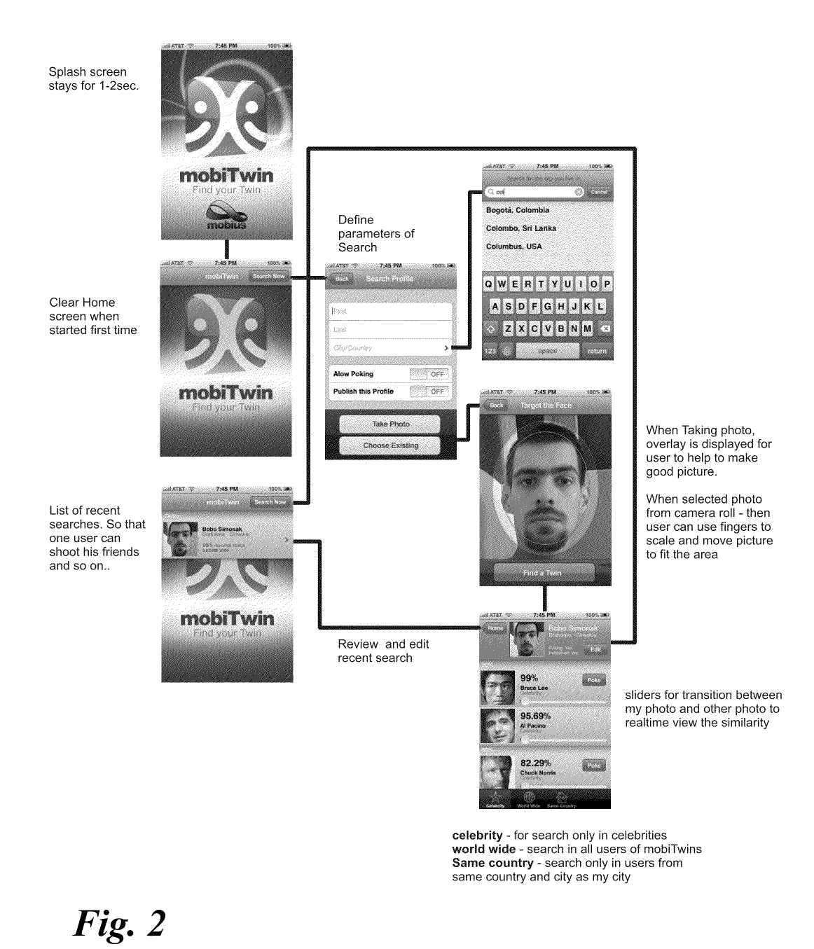

In another embodiment the present invention may be used as an amusement system. A user 12 records at 14 a facial image of a subject and sends the photo, via network 16, to a predetermined service provider comprising elements 20-28 at a known phone number or web site, and registers by supplying at 22 predetermined information such as name, physical address, email address telephone number, demographic information, etc. At 24, 26 the service provider utilizes the received image in conjunction with facial recognition equipment and an associated database to locate stored facial images of people resembling the subject. The service provider forwards at 28, via network 16, the stored images to the user at 30, along with information relating to the stored images. In some cases the stored images are of other users; in other cases the stored images may be of celebrities. Further details may be found in FIG. 2.

### XII. Product Tracing System

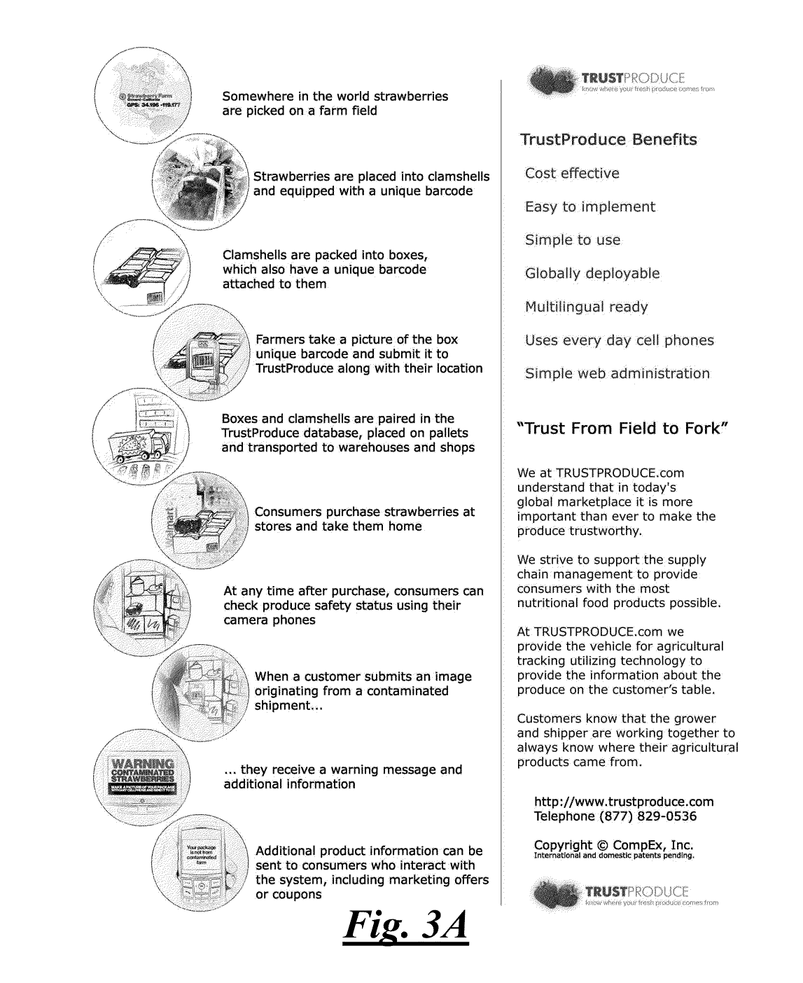

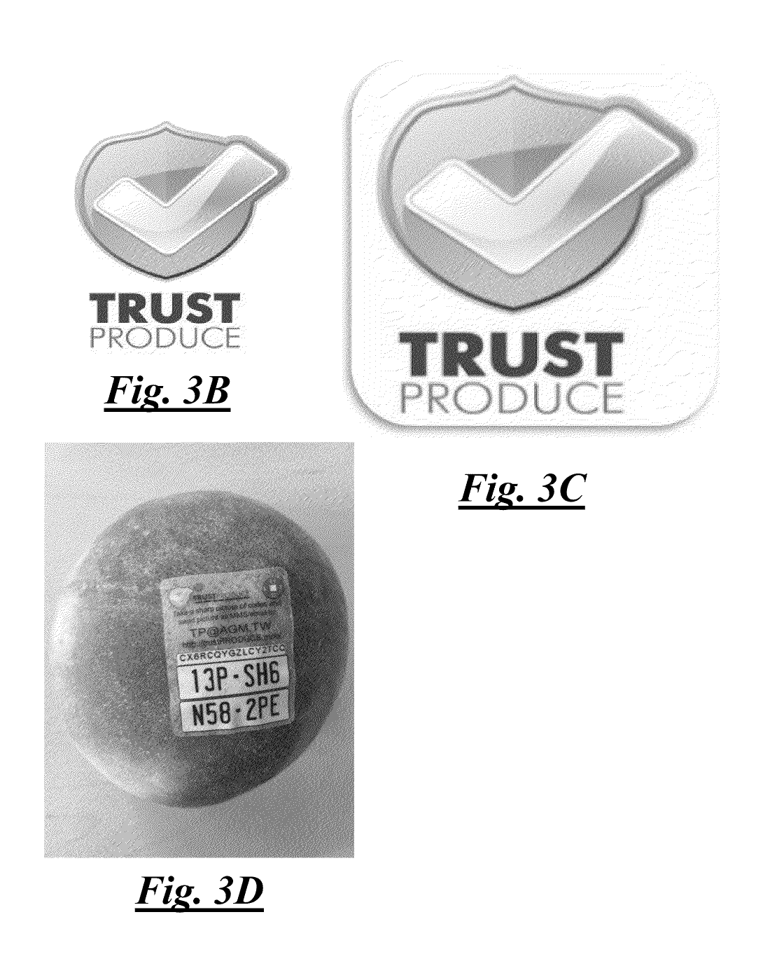

The present invention may be configured to tag goods such as farm products with information relating to the goods such as the type and variety, pick date, pick personnel, source of origin of the goods, and so on. The goods may be subsequently traced as they travel through various channels of commerce. Details of this embodiment of the present invention are provided in FIGS. 3A through 3D.

### XIII. Toy Recall Information System

The present invention may be used to communicate information relating to toy recalls. A user 12 records at 14 an image of a toy in question and sends the image at 18, via network 16, to a predetermined service provider comprising elements 20-28 at a known phone number or web site. The service provider sends at 28, via network 16, a response received by user 12 at 30. The response indicates whether or not the toy has been recalled. Additional information may also be provided, such as corrective actions, toy disposal instructions, toy return instructions, and a redeemable coupon for a replacement toy.

### XIV. Product Registration System

The present invention may be used to communicate product registration information. A user 12 records at 14 an image of the product, packaging or an identifying barcode and sends the image at 18, via network 16, to a predetermined service provider comprising elements 20-28 at a known phone number or web site. The service provider sends at 28, via network 16, a response received by user 12 at 30. The response indicates that the product has been registered. Additional information may also be provided, such as installation, set-up and operating instructions, optional or necessary ancillary equipment such as cables, purchase information and options for the ancillary equipment, and offers for extended warranties.

### XV. Memorial System

The present invention may be used as a way to remember loved ones. A user 12 records at 14 an image of a memorial marker and sends the image at 18, via network 16, to a predetermined service provider comprising elements 20-28 at a known phone number or web site. The service provider sends at 28, via network 16, a response received by user 12 at 30. The response contains information relating to the person associated with the memorial marker including, without limitation, text, still visually perceivable images and video images.

### XVI. Art Object Information System

The present invention may be used as a way to obtain information relating to art objects, such as paintings and sculptures. A user 12 records at 14 an image of an art object and sends the image at 18, via network 16, to a predetermined service provider comprising elements 20-28 at a known phone number or web site. The service provider sends at 28, via network 16, a response received by user 12 at 30. The response contains information relating to the art object including, without limitation, its history, price, options for purchasing the art object or related art objects, artist biographical information, kind of style of art, and when it was created.

### XVII. Real Estate Information System

The present invention may be used in connection with real estate sales. A user 12 records at 14 an image of real estate such as vacant property, a house or building and sends the image at 18, via network 16, to a predetermined service provider comprising elements 20-28 at a known phone number or web site. The service provider sends at 28, via network 16, a response received by user 12 at 30. The response contains information relating to the real estate including, without limitation, a video tour, images and information relating to its amenities, contact information for the realtor and means to generate and transmit to the realtor via system 10 an offer for the property. Sending a photograph of the agent's picture form the “For Sale” sign may also be used to display all of the agent's other listings, as well.

### XVIII. Medical Information System

The present invention may be used to obtain information relating to medicine. A user 12 records at 14 an image of a medical advertisement or container and sends the image at 18, via network 16, to a predetermined service provider comprising elements 20-28 at a known phone number or web site. The service provider sends at 28, via network 16, a response received by user 12 at 30. The response contains information relating to the medicine including, without limitation, how to take it, possible side effects and warnings relating to medicine comingling.

### XIX. Television Programming Recording System

The present invention may be used in connection with television programming. A user 12 records at 14 an image of a commercial advertisement relating to a television program or printed publication and sends the image at 18, via network 16, to a predetermined service provider comprising elements 20-28 at a known phone number or web site. The service provider sends at 28, via network 16, a response received by user 12 at 30. The response is received by a video recording device and is used to program the video recording device to record the program associated with the advertisement. System 10 may also be used by viewer 12 to communicate to the service provider the viewer's opinion of the program. Likewise, system 10 may be used to share the opinion of viewer 12 with others, such as friends, and to invite the viewer's friends to watch the program.

### XX. In-Store Advertising System

The present invention may be used in connection with in-store advertising. A user 12 records at 14 an image of an advertisement (such as floor stickers, wall stickers, shelf labels, actual product or product packaging, posters and so on that are on display in a store) and sends the image at 18, via network 16, to a predetermined service provider comprising elements 20-28 at a known phone number or web site. The service provider sends at 28, via network 16, a response received by user 12 at 30. The response contains information relating to the product including, without limitation, details relating to the product, additional advertising, recipes, serving suggestions and discount coupons.

### XXI. Outdoor Advertising System

The present invention may be used in connection with large-scale building wrap, billboards and other outdoor advertising. A user 12 records at 14 an image of the advertising and sends the image at 18, via network 16, to a predetermined service provider comprising elements 20-28 at a known phone number or web site. The service provider sends at 28, via network 16, a response received by user 12 at 30. The response contains information relating to the advertising including, without limitation, details relating to the advertised product or service, additional advertising, discount coupons, pricing information, sources for purchasing the products or services, and driving directions to the sources.

### XXII. Tavern-Related Advertising System

The present invention may be used in connection with tavern-related advertising such as advertising appearing on a drink coaster. A user 12 records at 14 an image of the advertising and sends the image at 18, via network 16, to a predetermined service provider comprising elements 20-28 at a known phone number or web site. The service provider sends at 28, via network 16, a response received by user 12 at 30. The response contains information relating to the advertising including, without limitation, details relating to the advertised product or service, additional advertising and discount coupons. The response may further provide entertainment, including “pickup lines” and other “icebreaker” conversation-starters for social settings.

### XXIII. Product Information System

The present invention may be used as a source of reference information. For example, a user 12 may record at 14 an image of a product or the product packaging, such as baby formula or food. The user sends the photo at 18, via network 16, to a predetermined service provider comprising elements 20-28 at a known phone number or web site, and registers at 22 by supplying predetermined information such as name, physical address, email address telephone number, demographic information, etc. The service provider subsequently sends at 28, via network 16, a text message or internet website link to the user at 30 with information relating to the product including, without limitation, ingredients, instructions for preparation and use, related products available and purchase information for the related products, coupons, and incentives such as lullaby recordings for playback.

### XXIV. Rewards Points System

The present invention may be used in connection with retailer- or other vendor-based rewards points systems wherein users collect and accumulate points for purchases, then “cash in” the accumulated points in exchange for goods, services, discounts or other incentives offered. A user 12 records at 14 an image of the purchased item (which may optionally include proof-of-purchase information) and sends the image at 18, via network 16, to a predetermined service provider comprising elements 20-28 at a known phone number or web site. The service provider tracks accumulated points at 24, 26 and sends at 28, via network 16, a response received by user 12 at 30. The response contains information relating to the transaction such as an accounting of the user's reward point balance. Additional information may include, without limitation, a listing of goods, services and discounts, and incentives for user 12 to obtain further accumulation of additional and/or bonus rewards points.

### XXV. Entertainment Information System

The present invention may be used as a source of information relating to entertainment venues, such as live theaters, comedy clubs and movie theaters. For example, a user 12 may record at 14 an image of an advertisement, such as poster or magazine advertisement, relating to the entertainment of interest. The user sends the photo at 18, via network 16, to a predetermined service provider comprising elements 20-28 at a known phone number or web site, and registers at 22 by supplying predetermined information such as name, physical address, email address telephone number, demographic information, etc. The service provider subsequently sends at 28, via network 16, a text message or internet website link to the user at 30 with information relating to the entertainment including, without limitation, movie trailers, details of the entertainment, time/date schedules, ticket prices, and nearby venues for the entertainment, such as nearby movie theaters. The present invention may also be used to purchase tickets for the entertainment.

### XXIV. Anti-Counterfeiting System

Products to be protected by the present invention are tagged or are otherwise marked with identifiers comprising a unique set of random codes and “watermarks,” either or both of which may or may not be visually perceivable. To check the product to determine whether it is genuine or counterfeit a user captures an image of the tag on the product and sends the image to a service provider as a photographic message. The service provider compares the image of the tag in the message to reference data stored in a database maintained by the service provider. The service provider determines, from the comparison, whether the product is genuine or counterfeit. If the product is genuine the service provider sends a certificate of authenticity to the sender of the image in the form of a validation certification code, which may include identifying information about the product and/or visually perceivable data on the tag that the user may compare to the certification code. If the product is counterfeit the service may warn the user accordingly.

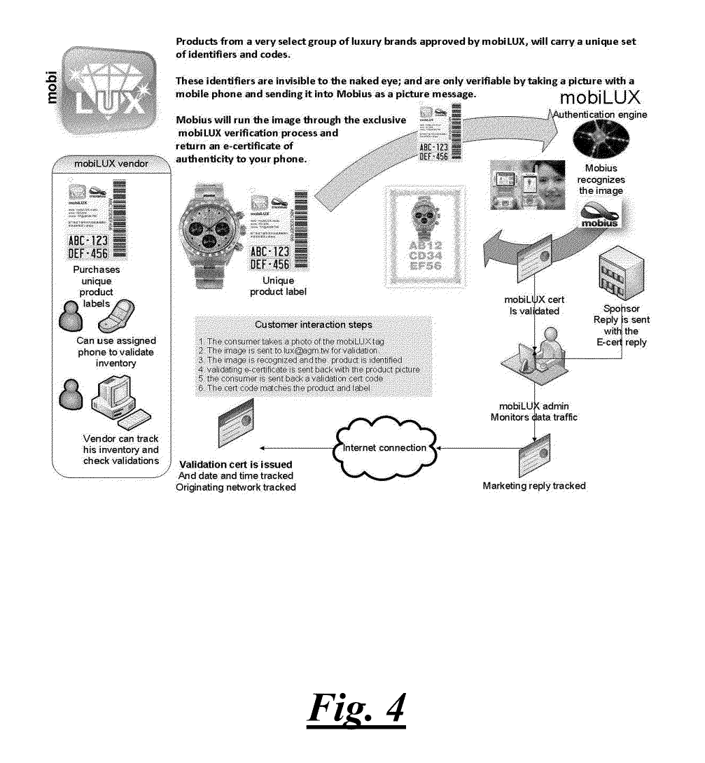

If the same identifiers appear in different locales and from different camera phones the identifiers are taken out of circulation by the service provider and are flagged as counterfeit. The codes may also have a predetermined shelf life if used on products having expiration dates, such as fruit, and would expire concurrently with the product. Further details of the present invention are provided in FIG. 4

While this invention has been shown and described with respect to a detailed embodiment thereof, it will be understood by those skilled in the art that changes in form and detail thereof may be made without departing from the scope of the claims of the invention.

What is claimed is:

1. A system for exchanging information relating to an electronic image, comprising:
at least one cellular telephone having an image recorder, a receiver and a transmitter;
a cellular telephone network to receive a recorded image transmitted by the cellular telephone and to re-transmit the recorded image to at least one remote server;
an image-recognition device accessible to the remote server, the image recognition device decoding the image and generating a corresponding dataset; and
a processor accessible to the remote server to generate a response corresponding to the dataset, the response being forwarded from the remote server to the receiver of the cellular telephone by means of the cellular telephone network.

2. The system of claim 1, wherein:
the cellular telephone is further equipped to transmit and receive data; and
a database is accessible to the remote server, the database storing data transmitted from the cellular telephone.

3. A method for exchanging information relating to an electronic image, comprising the steps of:
recording an image of interest with a camera-equipped cellular telephone;
utilizing a cellular telephone network to transmit the recorded image to at least one remote server;
decoding the image at the remote server to generate a corresponding dataset;
processing the dataset at the remote server in a predetermined manner to generate a response corresponding to the dataset; and
sending the response from the remote server to the cellular telephone by means of the cellular network.

4. The method of claim 3, further including the steps of:
providing a database accessible to the remote server;
transmitting, utilizing the cellular telephone network, data from the cellular telephone to the remote server; and
storing the data in the database.

5. The method of claim 3 wherein the image relates to a business acquaintance; and
wherein the response comprises information relating to the business acquaintance.

6. The method of claim 3 wherein the image relates to a loyalty card; and
wherein the response comprises information relating to the loyalty card.

7. The method of claim 3 wherein the image relates to a discount coupon; and
wherein the response comprises information relating to a price discount for goods and/or services associated with the image.

8. The method of claim 3 wherein the image relates to an air filter; and
wherein the response comprises at least one of reminder information and part number information relating to the air filter.

9. The method of claim 3 wherein the image relates to a sporting event; and
wherein the response comprises admission tickets relating to the sporting event.

10. The method of claim 3 wherein the image relates to a television advertisement for goods and/or services; and
wherein the response comprises information relating to the goods and/or services.

11. The method of claim 3 wherein the image relates to a refuse container; and
wherein the response comprises reminders relating to collection of the refuse container.

12. The method of claim 3 wherein the image relates to a vehicle; and
wherein the response comprises at least one of service reminder information and part number information relating to replacement components.

13. The method of claim 13 wherein the response comprises reference information relating to the image.

14. The method of claim 3 wherein the image relates to a consumer product; and
wherein the response comprises information relating to the consumer product.

15. The method of claim 3 wherein the image relates to a facial recognition amusement system; and
wherein the response comprises facial images similar to the image of interest.

16. The method of claim 3 wherein the image relates to a product tracing system; and
wherein the response comprises information relating to goods moving through channels of commerce.

17. The method of claim 3 wherein the image relates to a defective product recall system; and
wherein the response comprises information relating to recalled goods.

18. The method of claim 3 wherein the image relates to a product registration; and
wherein the response comprises information relating to registered products.

19. The method of claim 3 wherein the image relates to a memorial marker; and
wherein the response comprises information relating to persons associated with the memorial marker.

20. The method of claim 3 wherein the image relates to an art object; and
wherein the response comprises information relating to the art object.

21. The method of claim 3 wherein the image relates to real estate; and
wherein the response comprises information relating to the real estate.

22. The method of claim 3 wherein the image relates to a medication; and
wherein the response comprises information relating to the medication.

23. The method of claim 3 wherein the image relates to a television program; and
wherein the response comprises information relating to the program.

24. The method of claim 3 wherein the image relates to in-store advertising for goods and/or services; and
wherein the response comprises information relating to the advertised goods and/or services.

25. The method of claim 3 wherein the image relates to outdoor advertising for goods and/or services; and
wherein the response comprises information relating to the advertised goods and/or services.

26. The method of claim 3 wherein the image relates to tavern-related advertising for goods and/or services; and
wherein the response comprises information relating to the advertised goods and/or services.

27. The method of claim 3 wherein the image relates to a product package; and
wherein the response comprises information relating to the product.

28. The method of claim 3 wherein the image relates to purchased goods; and
wherein the response comprises information relating to rewards points for the purchased goods.

29. The method of claim 3 wherein the image relates to an entertainment venue; and
wherein the response comprises information relating to the entertainment venue.

30. The method of claim 3 wherein the image relates to a tag associated with a product; and
wherein the response comprises information relating to the counterfeit status of the product.
